(19) United States
(12) Patent Application Publication
(10) Pub. No.: US 2025/0296026 A1
(43) Pub. Date: Sep. 25, 2025

(54) AIR CLEANER

(71) Applicant: LG ELECTRONICS INC., Seoul (KR)

(72) Inventors: Sejin CHOI, Seoul (KR); Hojung KIM, Seoul (KR); Changkyum KIM, Seoul (KR); Chiyoung CHOI, Seoul (KR)

(73) Assignee: LG ELECTRONICS INC., Seoul (KR)

(21) Appl. No.: 19/081,608

(22) Filed: Mar. 17, 2025

(30) Foreign Application Priority Data
Mar. 20, 2024 (KR) 10-2024-0038502

(51) Int. Cl. B01D 46/00; B01D 46/24; B01D 46/42; B01D 46/58

(52) U.S. Cl. CPC B01D 46/0047; B01D 46/0002; B01D 46/0049; B01D 46/2403; B01D 46/4245; B01D 46/58; B01D 2265/028; B01D 2273/30

(57) ABSTRACT

Disclosed is an air cleaner including a case including a first suction port disposed at a peripheral surface of the case, an air cleaning module, a booster module removably mounted to an upper side of the air cleaning module, the booster module comprising a booster fan, an outer cover, and first and second fastening parts coupled to the outer cover, the first fastening part including a first plate, a first hook protruding outward from the first plate, a first support rod coupled to a lower side of the outer cover, and a first spring disposed between the first plate and the first support rod, and the second fastening part including a second plate, a second hook protruding outward from the second plate, a second support rod coupled to the lower side of the outer cover, and a second spring disposed between the second plate and the second support rod.

### CROSS-REFERENCE TO RELATED APPLICATION

This application claims the priority benefit of Korean Patent Application No. 10-2024-0038502, filed on Mar. 20, 2024 in the Korean Intellectual Property Office, the disclosure of which is incorporated herein by reference.

### BACKGROUND OF THE INVENTION

### 1. Field of the Invention

The present disclosure relates to an air cleaner, and more particularly to an air cleaner exhibiting improved air cleaning performance and convenience.

### 2. Description of the Related Art

An air cleaner is a device that filters air in a certain space and discharges the filtered air, thereby reducing the concentration of dust or bacteria in the air in the corresponding space. The air cleaner filters out foreign matter by generating a flow of air in the corresponding space, and discharges air with the foreign matter removed therefrom.

In order to quickly purify air in the indoor space, a discharge port may be formed in an upper portion of an air cleaner, and filtered air discharged upwardly may be guided so as to flow in all directions.

Further, in the case in which a discharge port is formed in an upper portion of an air cleaner, a separate fan for regulation of the direction of air discharged may be disposed at an upper portion of the air cleaner in order to cause filtered air to flow a long distance.

Research on a multistage air cleaner in which blowing devices are stacked vertically is underway.

A related art document (Korean Patent Laid-Open Publication No. 10-2022-0007365) relates to a circulator for an air cleaner. Such a related art document discloses an air cleaner in which a circulator is disposed above blowing devices disposed in an upward-downward direction in order to cause purified air to flow a long distance.

However, in the air cleaner disclosed in the above related art document, a stepper motor for rotating the circulator is disposed in a flow path and thus blocks a portion of the area of the flow path, thus deteriorating air cleaning performance.

Further, in the air cleaner disclosed in the above related art document, because a fan of the circulator is connected to and rotated by the shaft of a motor, vibration may occur.

Furthermore, because the circulator is coupled to a main body of the air cleaner, which is located therebelow, by means of screws, it is complicated to separate the circulator from the main body of the air cleaner. Thus, it is difficult to remove dust from a grille, an internal flow path, and a fan, which are provided in the main body of the air cleaner.

### SUMMARY OF THE INVENTION

An aspect of the present disclosure is directed to providing an air cleaner enabling convenient demounting and mounting of a booster module.

Another aspect of the present disclosure is directed to providing an air cleaner capable of facilitating maintenance and repair of internal parts.

A further aspect of the present disclosure is directed to providing an air cleaner capable of causing discharged purified air to circulate over a longer distance.

Still another aspect of the present disclosure is directed to providing an air cleaner capable of rotating a booster module without blocking an inner flow path, thereby improving air cleaning performance.

Still another aspect of the present disclosure is directed to providing an air cleaner capable of reducing vibration and noise of the booster module.

Still another aspect of the present disclosure is directed to providing an air cleaner capable of preventing discharged purified air from flowing back thereinto, thereby improving air cleaning performance.

Still another aspect of the present disclosure is directed to providing an air cleaner capable of preventing discharged purified air from flowing back thereinto without the necessity to add a structure such as a partition plate, thereby having a reduced size.

Still another aspect of the present disclosure is directed to providing an air cleaner capable of forming an airflow that effectively removes allergens causing allergies.

The aspects of the present disclosure are not limited to the aspects mentioned above, and other aspects not mentioned herein will be clearly understood by those skilled in the art from the following description.

An air cleaner according to an embodiment of the present disclosure may cause purified air to circulate over a longer distance using a booster module removably mounted to an upper side of an air cleaning module.

An air cleaner according to an embodiment of the present disclosure may enable convenient mounting and demounting of a booster module using a pair of fastening parts coupled to a lower side of the booster module.

An air cleaner according to an embodiment of the present disclosure includes a case having a suction port formed in the peripheral surface thereof, an air cleaning module including a blower fan disposed in the case and a filter configured to remove foreign matter from air introduced through the suction port, a booster module removably mounted to an upper side of the air cleaning module, and a booster neck configured to support the booster module.

The booster module includes a booster fan, a booster motor configured to rotate the booster fan, an outer cover, and first and second fastening parts coupled to the outer cover.

The first fastening part includes a first plate, a first hook protruding outward from the first plate to be coupled to the booster neck, a first support rod coupled to a lower side of the outer cover, and a first spring disposed between the first plate and the first support rod.

The second fastening part includes a second plate, a second hook protruding outward from the second plate to be coupled to the booster neck, a second support rod coupled to a lower side of the outer cover, and a second spring disposed between the second plate and the second support rod.

A first protruding portion may be formed on one surface of the first plate so as to protrude toward the first support rod and to allow the first spring to be wound therearound.

A second protruding portion may be formed on one surface of the second plate so as to protrude toward the second support rod and to allow the second spring to be wound therearound.

A third protruding portion may be formed on the surface of the first plate at a position below the first protruding portion so as to protrude toward the first support rod.

A fourth protruding portion may be formed on the surface of the second plate at a position below the second protruding portion so as to protrude toward the second support rod.

The booster module may further include a power module including a second terminal formed to be in contact with a first terminal of the air cleaning module.

The second terminal may be exposed downwardly between the first support rod and the second support rod.

The booster neck may include a neck plate, a neck base extending upward from the neck plate to support the outer cover from below, a first seating portion protruding upward from the inside of the neck base, and a second seating portion protruding downward from the neck plate.

The second seating portion may include a first space defined therein so as to allow the first support rod to be inserted thereinto and a second space defined therein so as to allow the second support rod to be inserted thereinto.

The neck base may include sidewalls, each of which has a hole formed therein, and a rear wall interconnecting the sidewalls, and the sidewalls may include sections having a smaller height than the rear wall.

The air cleaner may further include a button module including a button inserted into the hole, a body supporting the button, and a protrusion protruding from a rear surface of the body.

The air cleaner may further include a rear cover including a coupling portion coupled to the outer cover, a grille portion connected to the coupling portion and having a suction port formed therein, and an opening formed therein so as to allow a portion of the outer cover to pass therethrough.

The outer cover may include a booster base, a first part protruding from the booster base and having a fastening hole formed therein so as to be fastened to the rear cover using a fastening member, and a second part protruding from the first part to cover the opening. The first fastening part and the second fastening part may be coupled to the second part.

The air cleaning module may include a first air cleaning module having a first discharge port formed in the bottom thereof and a second air cleaning module disposed above the first air cleaning module and having a second discharge port formed in the top thereof. Air with foreign matter removed therefrom by the first air cleaning module may be discharged through the first discharge port, and air with foreign matter removed therefrom by the second air cleaning module may be discharged through the second discharge port.

The booster module may further include an inner grille disposed inside the outer cover and having a discharge port formed therein and a rear suction grille having a suction port formed therein, and the booster fan may be disposed on the front surface of the rear suction grille and may be disposed inside the inner grille.

The booster module may further include a display panel disposed on the front surface of the booster fan and an inner flow guide disposed between the outer cover and the inner grille to change the flow direction of air discharged through the discharge port of the inner grille, and the air discharged through the discharge port of the inner grille may pass through a slit formed between the inner flow guide and the display panel.

The booster fan may be a sirocco fan, and the booster motor may be an outer rotor type motor.

A rotating part of the booster motor may be inserted into a central depressed portion of the booster fan.

An air cleaner according to another embodiment of the present disclosure includes a case having a suction port formed in the peripheral surface thereof, an air cleaning module including a blower fan disposed in the case and a filter configured to remove foreign matter from air introduced through the suction port, a booster module removably mounted to an upper side of the air cleaning module, the booster module including a power module configured to receive power from a first terminal of the air cleaning module, a booster fan, and a booster motor configured to rotate the booster fan, and a booster neck configured to support the booster module. The power module includes a second terminal exposed downwardly from the booster neck so as to be in contact with the first terminal.

The booster neck may include a lower cover forming a bottom surface of the booster neck, a ring-shaped first peripheral portion disposed outside a periphery of the lower cover and protruding downward from the lower cover, and a hook disposed on a protruding side surface of the first peripheral portion.

The lower cover may include an open portion to allow the second terminal to be exposed downwardly therethrough.

The air cleaning module may further include an upper discharge grille forming a discharge port in the top of the air cleaning module, an upper case located inside the upper discharge grille, and a lower case located below the upper case and having a space defined therein so as to accommodate a wire connected to the first terminal.

The lower case may include a ring-shaped surface having a central cavity formed therein.

The booster module may further include a display panel disposed on the front surface of the booster fan and an inner flow guide disposed between the outer cover and the inner grille to change the flow direction of air discharged through the discharge port of the inner grille, and the air discharged through the discharge port of the inner grille may pass through a slit formed between the inner flow guide and the display panel.

The booster fan may be a sirocco fan, the booster motor may be an outer rotor type motor, and a rotating part of the booster motor may be inserted into a central depressed portion of the booster fan.

The air cleaning module may include a first air cleaning module having a first discharge port formed in the bottom thereof and a second air cleaning module disposed above the first air cleaning module and having a second discharge port formed in the top thereof. Air with foreign matter removed therefrom by the first air cleaning module may be discharged through the first discharge port, and air with foreign matter removed therefrom by the second air cleaning module may be discharged through the second discharge port.

### BRIEF DESCRIPTION OF THE DRAWINGS

The above and other objects, features, and other advantages of the present disclosure will be more clearly understood from the following detailed description taken in conjunction with the accompanying drawings, in which:

FIG. 1 is a perspective view of an air cleaner according to an embodiment of the present disclosure;

FIG. 2 is a cross-sectional view of the air cleaner according to the embodiment of the present disclosure;

FIG. 3 is a view showing an airflow generated by the air cleaner according to the embodiment of the present disclosure;

FIG. 4 is an exploded view of the air cleaner according to the embodiment of the present disclosure;

FIG. 5 is an assembled view of a booster module according to the embodiment of the present disclosure;

FIGS. 6 and 7 are exploded views of the booster module according to the embodiment of the present disclosure;

FIG. 8 is a cross-sectional view of the booster module according to the embodiment of the present disclosure;

FIG. 9 is a view showing an airflow in the booster module according to the embodiment of the present disclosure;

FIG. 10 is a view for explaining a fan motor module of the booster module according to the embodiment of the present disclosure;

FIG. 11 is a cross-sectional view of the booster module according to the embodiment of the present disclosure;

FIG. 12 is a bottom view of the booster module according to the embodiment of the present disclosure;

FIG. 13 is a view for explaining rotational operation of the booster module according to the embodiment of the present disclosure;

FIG. 14 is a view for explaining mounting and demounting of the booster module according to the embodiment of the present disclosure;

FIGS. 15 and 16 are exploded views of the booster module according to the embodiment of the present disclosure;

FIGS. 17 to 22 are views for explaining mounting and demounting of the booster module according to the embodiment of the present disclosure;

FIGS. 23 and 24 are enlarged cross-sectional views showing the coupling structure of the booster module according to the embodiment of the present disclosure; and

FIG. 25 is a cross-sectional view of the booster module according to the embodiment of the present disclosure.

### DETAILED DESCRIPTION

Hereinafter, embodiments of the present disclosure will be described in detail with reference to the accompanying drawings. The present disclosure may, however, be embodied in many different forms, and should not be construed as being limited to the embodiments set forth herein.

In the drawings, illustration of parts unrelated to the description is omitted to clearly and briefly describe the present disclosure, and the same or extremely similar components are denoted by the same reference numerals throughout the specification.

As used herein, the terms with which the names of components are suffixed, “module” and “unit”, are assigned to facilitate preparation of this specification, and are not intended to suggest unique meanings or functions. Accordingly, the terms “module” and “unit” may be used interchangeably.

It will be understood that although the terms “first”, “second”, etc., may be used herein to describe various components, these components should not be limited by these terms. These terms are only used to distinguish one component from another component.

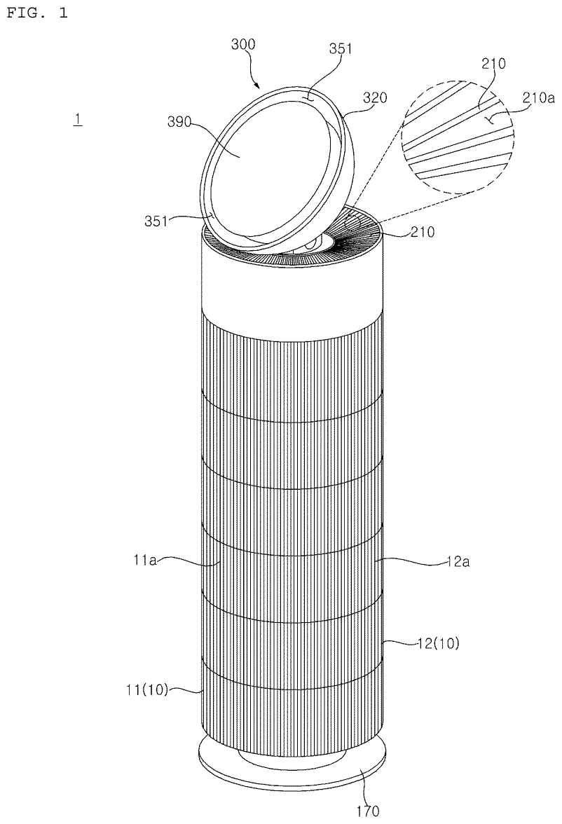

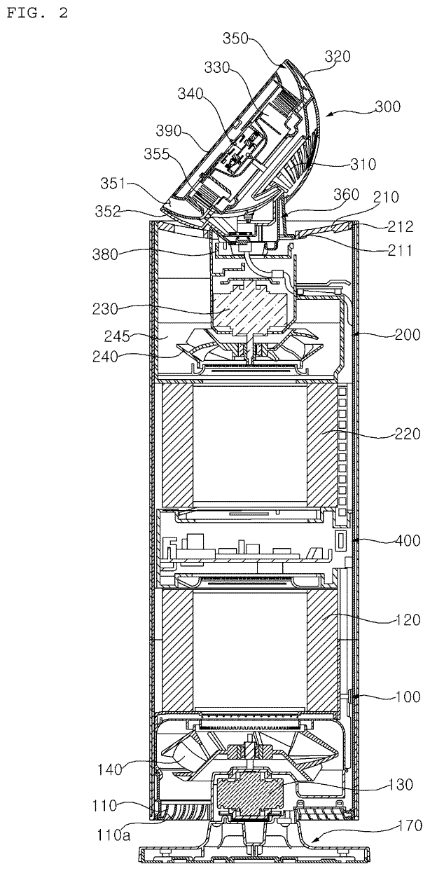

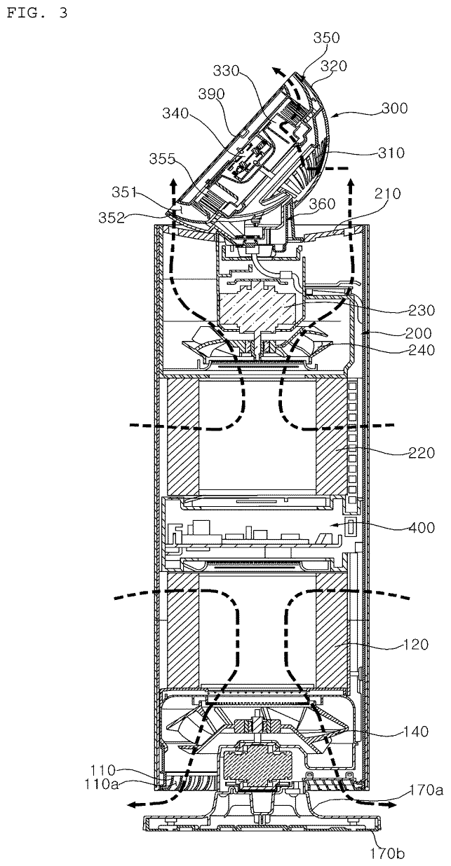

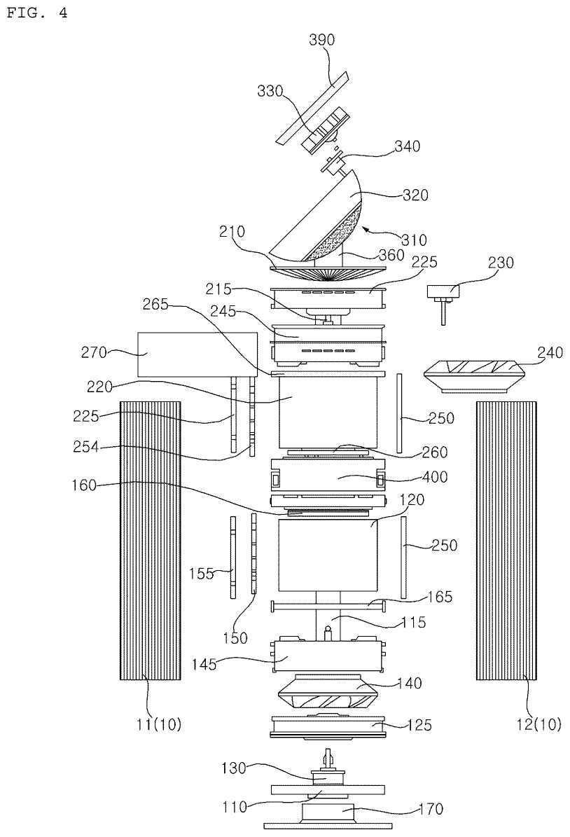

FIG. 1 is a perspective view of an air cleaner according to an embodiment of the present disclosure. FIG. 2 is a cross-sectional view of the air cleaner according to the embodiment of the present disclosure, and FIG. 3 is a view showing an airflow generated by the air cleaner according to the embodiment of the present disclosure. FIG. 4 is an exploded view of the air cleaner according to the embodiment of the present disclosure.

Referring to FIGS. 1 to 4, the air cleaner 1 includes a case 10 forming the external appearance thereof. The case 10 may have suction ports 11a and 12a formed in the peripheral surface thereof to suction air from various directions. Air may be suctioned from all directions with respect to a central line passing through the internal center of the case 10 in an upward-downward direction. The suction ports 11a and 12a are provided in plural, and the plurality of suction ports 11a and 12a is spaced apart from each other in the circumferential direction of the case 10. The plurality of suction ports 11a and 12a is evenly formed in the circumferential direction along the peripheral surface of the case 10 so that air is capable of being suctioned into the case 10 from any direction.

In this specification, the upward-downward direction or the vertical direction is defined as an axial direction. The axial direction may correspond to the central axis-direction of blower fans 140 and 240, which will be described later, i.e., the motor shaft direction of the fans. The radial direction or the horizontal direction may be understood as a direction perpendicular to the axial direction. The circumferential direction may be understood as a circumferential direction of an imaginary circle that is formed when rotating about the axial direction with a distance in the radial direction as a rotational radius.

The air cleaner 1 includes air cleaning modules 100 and 200 that generate airflows. The air cleaning modules 100 and 200 include blower fans 140 and 240, which are disposed in the case 10, and filters 120 and 220, which remove foreign matter from air introduced through the suction ports 11a and 12a, respectively.

The air introduced through the suction ports 11a and 12a may pass through the filters 120 and 220. Each of the filters 120 and 220 may be formed in a cylindrical shape and may have a filter surface that filters air.

The case 10 may have a cylindrical shape. The case 10 may include a first case 11, which has a semi-cylindrical shape and covers portions of the outer circumferential surfaces of the air cleaning modules 100 and 200, and a second case 12, which has a semi-cylindrical shape and covers the remaining portions of the outer circumferential surfaces of the air cleaning modules 100 and 200.

Alternatively, the case 10 may have a shape of a truncated cone (a cone with the top cut off), and each of the first case 11 and the second case 12 may have a shape of a semi-truncated cone.

The first case 11 and the second case 12 may be coupled to each other to form the external appearance of the air cleaner 1. Because the first case 11 covers the front surface of the air cleaner 1, the first case 11 may be referred to as a “front case” or a “front cover”. Because the second case 12 covers the rear surface of the air cleaner 1, the second case 12 may be referred to as a “rear case” or a “rear cover”.

The suction ports 11a and 12a include a first suction port 11a formed in the first case 11 and a second suction port 12a formed in the second case 12. The suction ports 11a and 12a allow the inside of the case 10 and the outside to communicate with each other. The suction ports 11a and 12a are provided in plural. The plurality of suction ports 11a and 12a may be formed in the peripheral surface of the case 10.

The plurality of suction ports 11a and 12a is evenly formed in the circumferential direction along the outer circumferential surface of the case 10 so that air is capable of being suctioned into the case 10 from any direction.

The plurality of suction ports 11a and 12a is formed in a stripe shape that is elongated in the upward-downward direction. Alternatively, the plurality of suction ports 11a and 12a may be formed through perforation in a circular or elliptical shape.

As described above, because the case 10 is formed in a cylindrical shape and the plurality of suction ports 11a and 12a is formed along the outer circumferential surface of the case 10, the amount of air suctioned may increase.

Referring to FIGS. 1 to 4, the air cleaning modules 100 and 200 include a first air cleaning module 100 and a second air cleaning module 200 that are disposed in the upward-downward direction.

For example, the second air cleaning module 200 may be disposed above the first air cleaning module 100. Because the first air cleaning module 100 is disposed at a lower portion of the air cleaner 1, the first air cleaning module 100 may be referred to as a “lower air cleaning module” or a “lower module”, and because the second air cleaning module 200 is disposed at an upper portion of the air cleaner 1, the second air cleaning module 200 may be referred to as an “upper air cleaning module” or an “upper module”.

The first air cleaning module 100 and the second air cleaning module 200 include blower fans 140 and 240 and filters 120 and 220 configured to remove foreign matter from air introduced through the suction ports 11a and 12a, respectively.

The first air cleaning module 100 includes a first blower fan 140 and a first filter 120 configured to remove foreign matter from air introduced through the suction ports. In addition, the first air cleaning module 100 further includes a first fan motor 130 configured to rotate the first blower fan 140.

The second air cleaning module 200 includes a second blower fan 240 and a second filter 220 configured to remove foreign matter from air introduced through the suction ports. In addition, the second air cleaning module 200 further includes a second fan motor 230 configured to rotate the second blower fan 240.

The air cleaning modules 100 and 200 include a first discharge port 110a formed in the bottom of the air cleaning module 100 and a second discharge port 210a formed in the top of the air cleaning module 200. The first discharge port 110a is formed below the first blower fan 140 and the first filter 120. The second discharge port 210a is formed above the second blower fan 240 and the second filter 220. Air with foreign matter removed therefrom by the filters 120 and 220 is discharged downwardly through the first discharge port 110a and is discharged upwardly through the second discharge port 210a.

In the case in which the second air cleaning module 200 is disposed above the first air cleaning module 100, the first discharge port 110a is formed in the bottom of the first air cleaning module 100, and the second discharge port 210a is formed in the top of the second air cleaning module 200.

In addition, a lower discharge grille 110 including a plurality of grilles is disposed at the bottom of the first air cleaning module 100 in order to guide a lower airflow. In addition, an upper discharge grille 210 including a plurality of grilles is disposed at the top of the second air cleaning module 200 in order to guide an upper airflow.

The upper discharge grille 210 may include an inner wall 211 and an outer wall 212, which have a cylindrical shape. The plurality of grilles of the upper discharge grille 210 may interconnect the inner wall 211 and the outer wall 212 and may be disposed in a radial form.

The lower discharge grille 110 may include a plurality of grilles having a concentric circle structure. The plurality of grilles may be a plurality of circles having the same center and different radii. Each of the plurality of grilles may include a section bent in the radially outward direction. The lower discharge grille 110 may include a plurality of grilles bent at a predetermined angle in the outward direction. The lower discharge grille 110 may be disposed inside the discharge port 110a in order to deliver the lower discharge airflow in the lateral direction.

A bottom plate 170 is disposed below the first air cleaning module 100. The bottom plate 170 is disposed in contact with the floor to support the air cleaning modules 100 and 200.

An airflow guide 170a is disposed on the upper surface of the bottom plate 170 in order to guide air discharged downwardly through the first discharge port 110a in the lateral direction. The bottom plate 170 may further include a base 170b that supports the airflow guide 170a. The airflow guide 170a may be formed on the upper surface of the base 170b. In addition, the airflow guide 170a and the base 170b may be coupled to each other to constitute the bottom plate 170.

Air with foreign matter removed therefrom by the first filter 120 is discharged in the downward direction through the first discharge port 110a. Air with foreign matter removed therefrom by the second filter 220 is discharged in the upward direction through the second discharge port 210a.

According to the present disclosure, although two air cleaning modules are stacked vertically, air is not discharged upwardly from the lower air cleaning module. Therefore, while suction performance is improved by forming the suction ports 11a and 12a in the peripheral surface of the case 10, it is possible to prevent air discharged from the lower air cleaning module from flowing back into the upper air cleaning module.

The conventional 2-stage air cleaner has a problem in that purified air discharged from the lower air cleaning module flows upward and is suctioned into the upper air cleaning module, whereby air cleaning performance is reduced. In contrast, according to the present disclosure, purified air discharged from the lower air cleaning module flows downward, and thus introduction of the purified air into the upper air cleaning module is prevented, whereby air cleaning performance is improved.

Further, according to the present disclosure, since the air cleaner 1 does not need to have a structure for preventing introduction of purified air discharged therefrom or a configuration for discharge, the overall size of the product may be further reduced, and the freedom of design such as placement of internal parts may be improved.

For example, a control module 400 may be disposed at the center of the air cleaner 1, thereby reducing the lengths of power lines and signal lines, simplifying a line connection structure, and reducing the overall height of the product. Further, the control module 400 may be disposed between the air cleaning modules 100 and 200 so that the air cleaning modules 100 and 200 are controlled by the single integrated control module 400. Accordingly, each of the air cleaning modules 100 and 200 does not need to include an individual control module, and thus the overall height of the product may be reduced.

General allergen particles have a size of about 3 μm to about 100 μm, which is greater than the size of fine dust, and thus tend to settle on the floor. The lower airflow discharged downwardly from the first air cleaning module 100 causes allergen particles to float in the air and thus to be collected by the filters 120 and 220. In this way, it is possible to effectively remove allergens causing allergies using the lower airflow discharged downwardly from the first air cleaning module 100.

In addition, the air cleaner 1 may include a UVC LED, which is disposed in the case 10 and outputs ultraviolet in a wavelength band that has a sterilization effect on bacteria, mold, and microorganisms, and an ionizer, which is disposed in the case 10 and eliminates germs and mold using electricity supplied thereto.

In addition, the air cleaning modules 100 and 200 include fan housings 145 and 245 accommodating the blower fans 140 and 240 and a plurality of support parts 150 and 250 extending in the vertical direction from the fan housings 145 and 245. The support parts 150 and 250 may extend in the longitudinal direction of the air cleaner 1. The number of support parts 150 and 250 may be varied depending on the size or specifications of the product. The support parts 150 and 250 may extend in the longitudinal direction of the air cleaner 1. Some of the support parts 150 and 250 may be different in at least one of shape, size, or material from the remaining ones of the support parts 150 and 250.

Each of wire covers 155 and 255 may be disposed on at least one surface of a respective one of the plurality of support parts 150 and 250 so as to cover a respective one of the support parts 150 and 250. The support parts 150 and 250 and the wire covers 155 and 255 may be spaced apart from each other to define spaces in which wires or the like are disposed.

In addition, the air cleaning modules 100 and 200 may further include wire covers 115 and 215, inside which wires or the like are disposed. The fan motors 130 and 230 may be accommodated in motor fastening parts 125 and 225, respectively.

The air cleaning modules 100 and 200 include filter mounting parts 160 and 260 in which the filters 120 and 220 are mounted, respectively. The control module 400 is disposed between the filter mounting parts 160 and 260.

Steel nets 165 and 265 are disposed between the filters 120 and 220 and the blower fans 140 and 240 in order to prevent body parts of the user or any other object from entering the spaces in which the blower fans 140 and 240 are disposed.

A top cover 270 is disposed on the top of the case 10. The upper discharge grille 210 is disposed inside the top cover 270.

In addition, a booster module 300 that regulates the direction of air discharged through the second discharge port 210a may be disposed above the air cleaning modules 100 and 200. The booster module 300 may be disposed above the second air cleaning module 200 in order to change the discharge direction of the airflow generated by the second air cleaning module 200.

The booster module 300 may send air discharged from the second air cleaning module 200 farther away. In addition, the booster module 300 may blend an airflow while rotating left and right, thereby forming various types of airflows. In some embodiments, the booster module 300 may move in the upward-downward direction so as to form a wider variety of airflows.

The booster module 300 may be removably mounted to the top of the second air cleaning module 200. In addition, a contact power supply structure may be applied to the booster module 300 and the second air cleaning module 200, so that power is supplied from the second air cleaning module 200 to the booster module 300 when the booster module 300 is mounted to the second air cleaning module 200.

When internal parts of the booster module 300, such as a booster fan 330, need to be washed, or when the upper discharge grille 210 disposed at the top of the second air cleaning module 200 needs to be cleaned, the booster module 300 may be removed. In this way, it is possible to conveniently keep the product hygienic.

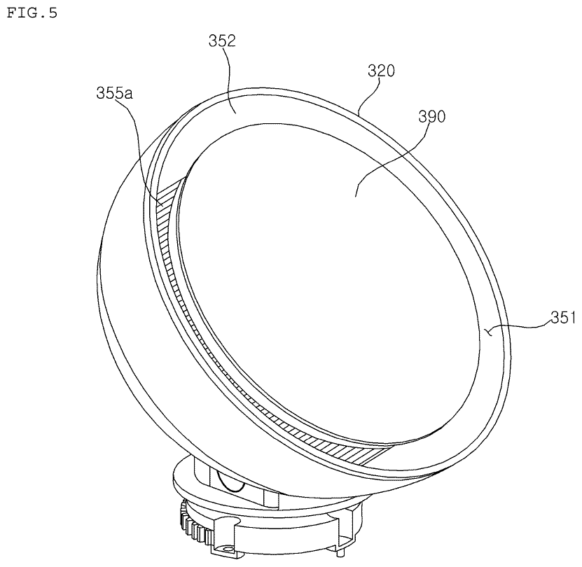

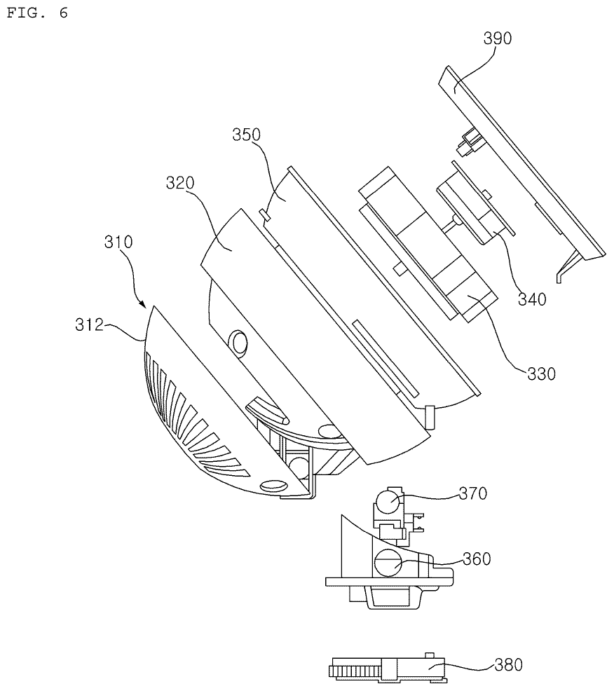

The booster module 300 includes an outer cover 320, an inner grille 355 disposed inside the outer cover 320 and having a discharge port 355a (refer to FIG. 5) formed therein, a rear suction grille 311 having a suction port 311a (refer to FIG. 6) formed therein, a booster fan 330 disposed on the front surface of the rear suction grille 311 and disposed inside the inner grille 355, and a motor 340 configured to rotate the booster fan 330.

The rear suction grille 311 may be a part of a rear cover 310 that forms the external appearance of the rear surface of the booster module 300. Alternatively, the rear suction grille 311 may be provided separately and coupled to the rear cover 310.

The rear cover 310 may have an opening formed therein so as to allow a portion of the upper end of a booster neck 360 to pass therethrough. In addition, the rear cover 310 may be coupled to the booster neck 360 by means of a predetermined fastening member.

The booster module 300 may be supported by the booster neck 360 and may be mounted to the second air cleaning module 200.

The booster module 300 may be provided so as to be movable. The booster module 300 may be maintained in an inclined state or a lying state, as shown in FIG. 1.

The booster module 300 further includes a display panel 390 disposed on the front surface of the booster fan 330. The display panel 390 may cover the entirety of the front surface of the booster fan 330. The motor 340 may be disposed inside the booster fan 330.

The booster fan 330 may be a sirocco fan. If the booster fan 330 is implemented as a mixed-flow fan, an airflow is discharged through the front grille. However, the sirocco fan may discharge an airflow through the inner grille 355 formed laterally. Accordingly, it is possible to place the display panel 390 on the front surface of the fan, thereby shielding the fan structure. In addition, the sirocco fan has an advantage of reducing noise compared to the mixed-flow fan.

In addition, the booster module 300 further includes an inner flow guide 350 disposed between the outer cover 320 and the inner grille 355 in order to change the flow direction of air discharged through the discharge port 355a of the inner grille 355.

A slit 351 is formed between the inner flow guide 350 and the display panel 390. The air discharged through the discharge port 355a of the inner grille 355 passes through the slit 351, and then is discharged from the booster module 300.

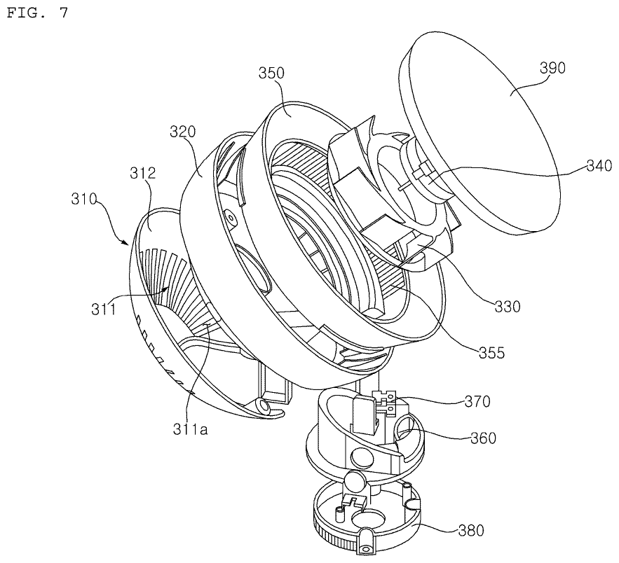

FIG. 5 is an assembled view of the booster module according to the embodiment of the present disclosure, and FIGS. 6 and 7 are exploded views of the booster module according to the embodiment of the present disclosure.

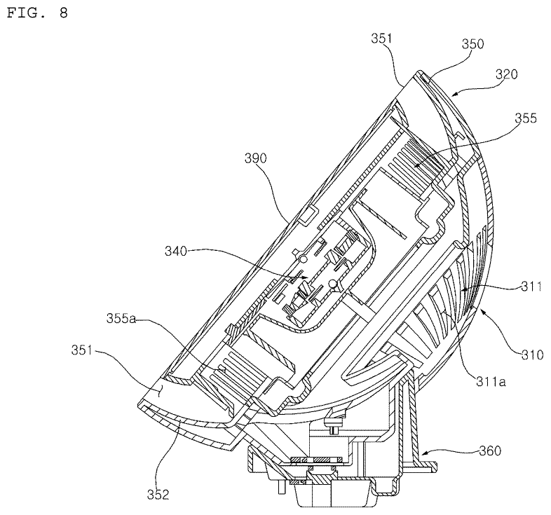

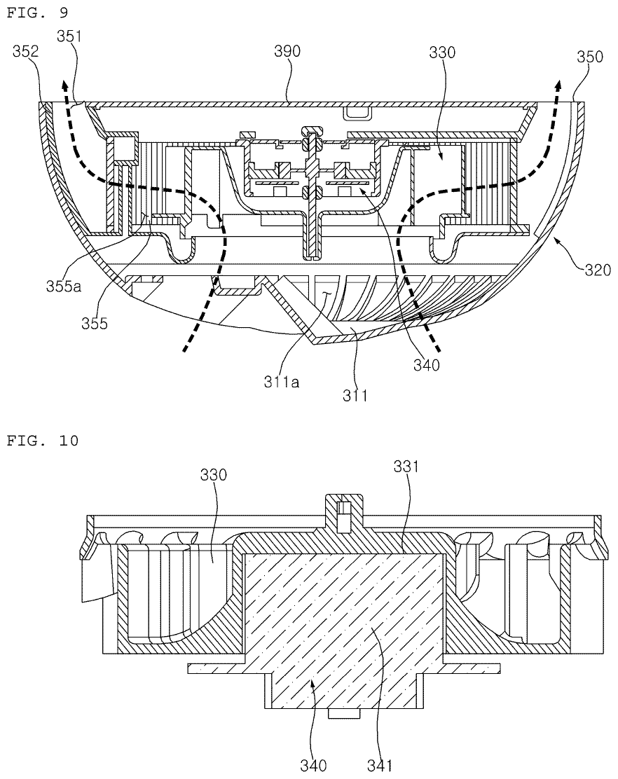

FIG. 8 is a cross-sectional view of the booster module according to the embodiment of the present disclosure, and FIG. 9 is a view showing an airflow in the booster module according to the embodiment of the present disclosure.

Referring to FIGS. 5 to 9, the display panel 390 that displays information about operation of the air cleaner 1 is disposed at the front of the booster module 300. The display panel 390 may move together with the booster module 300. The user may more easily view the information displayed on the display panel 390 disposed at the top of the product.

The booster fan 330 and the booster motor 340 are disposed on the rear surface of the display panel 390. The booster motor 340 is disposed inside the booster fan 330. The display panel 390 covers the entireties of the front surfaces of the booster fan 330 and the booster motor 340, thereby preventing exposure of the booster fan 330 to the user.

The booster fan 330 may be a sirocco fan. If the booster fan 330 is implemented as a mixed-flow fan, air flows forward. Thus, the mixed-flow fan is not suitable for the slit-type flow path, and a front grille is required. However, if the booster fan 330 is implemented as a sirocco fan, resistance to an airflow discharged through the slit structure is reduced. Thus, the sirocco fan is suitable for the slit structure, and a front grille is eliminated. Accordingly, the fan and the inner grille are not visible from the outside.

The rear cover 310 and the outer cover 320 are coupled to each other to define a space in which parts are accommodated. The booster fan 330 and the booster motor 340 may be disposed in the inner space of the outer cover 320.

The inner grille 355 in which the discharge port 355a is formed and the inner flow guide 350 that changes the flow direction of air discharged through the discharge port 355a of the inner grille 355 are disposed between the outer cover 320 and the booster fan 330.

The inner grille 355 is disposed on the lateral side of the booster fan 330. The airflow caused by rotation of the booster fan 330 occurs along the discharge port 355a of the inner grille 355 formed laterally and the inner flow guide 350.

An inner flow path 352 including a forwardly curved surface is disposed on the inner surface of the inner flow guide 350. An end portion of the inner flow guide 350 and an end portion of the display panel 390 may be spaced a predetermined interval from each other to form the slit 351.

The air discharged through the discharge port 355a of the inner grille 355 passes through the inner flow path 352 and the slit 351, and then is discharged from the booster module 300.

According to the present disclosure, because an airflow is discharged through the slit 351, it is possible to minimize accumulation of dust on the booster fan 330 and the grille 355. Further, because the fan 330 and the grille 355 are not visible from the outside, the aesthetics of the product may be improved.

According to the present disclosure, an airflow is delivered through the inner grille 355 disposed on the lateral side of the booster fan 330, the inner flow path 352, and the slit 351, the blades of the booster fan 330 are not visible from the outside, and the size of the motor 340 is reduced. Further, according to the present disclosure, because a front grille is eliminated, it is possible to solve a problem of dust accumulating on a front grille.

The rear cover 310 includes a coupling portion 312 coupled to the outer cover 320 and a grille portion 311 in which the suction port 311a is formed. The grille portion 311 may include a plurality of grilles, and may be the aforementioned rear suction grille 311. The rear surface of the outer cover 320 may be formed corresponding to the shape of the coupling portion 312 and the coupling structure. For example, a stepped portion may be formed at the rear side of the outer cover 320, and a coupling member formed to be coupled to the coupling portion 312 may be disposed on the stepped portion so that the contours of the rear cover 310 and the outer cover 320 are smoothly connected when the rear cover 310 and the outer cover 320 are coupled to each other. The outer cover 320 may be coupled to the inner flow guide 350 using a coupling member formed on the inner surface thereof.

An assembly of components from the display panel 390 disposed at the front side to the rear suction grille 311 disposed at the rear side, which are disposed at the top of the air cleaner 1, may be referred to as a “booster head”.

The booster module 300 (or the booster head) is coupled to and supported by the booster neck 360. The booster neck 360 is coupled to the air cleaning modules 100 and 200, which correspond to the main body of the air cleaner 1.

The booster neck 360 may be coupled to the top of the second air cleaning module 200. Accordingly, at least a portion of the purified air discharged through the second discharge port 210a formed in the top of the second air cleaning module 200 may flow into the suction portion 311a of the rear suction grille 311.

The upper portion of the booster neck 360 may be coupled to the booster module 300. The lower portion of the booster neck 360 may be connected to the second air cleaning module 200. In order to further facilitate connection between the booster neck 360 and the second air cleaning module 200, a protruding portion may be formed at the lower portion of the booster neck 360 so as to protrude downward.

A head rotating part 380 may be located below the booster neck 360. The head rotating part 380 may be located inside the inner wall 211 of the upper discharge grille 210. The head rotating part 380 may include a structure for rotating the booster module 300 and a case for accommodating internal components, and may be connected to or accommodate components such as a stepper motor, an ionizer, and wires.

The upper end of the head rotating part 380 may be coupled to the booster neck 360. The lower end of the head rotating part 380 may be coupled to another mechanical structure of the second air cleaning module 200. For example, the lower end of the head rotating part 380 may be coupled to an upper side of the second fan housing 245. Alternatively, the lower end of the head rotating part 380 may be coupled to an upper side of the second motor fastening part 225. In another embodiment, a separate coupling part may be provided between the lower end of the head rotating part 380 and the upper end of the second fan housing 245 or the second motor fastening part 225.

The booster module 300 includes a power module 370. The power module 370 may include a power line for supply of power, a signal line for transmission of signals, and a terminal connected to the power line and the signal line.

When the booster module 300 is mounted to the second air cleaning module 200, the terminal of the power module 370 may come into contact with the terminal of the second air cleaning module 200, and accordingly, the power module 370 may receive power from the second air cleaning module 200.

FIG. 10 is a view for explaining a fan motor module of the booster module according to the embodiment of the present disclosure.

Referring to FIG. 10, the booster fan 330 and the booster motor 340 described above may be formed integrally to constitute a fan motor module 330 and 340. The booster motor 340 may be located at the inner center of the booster fan 330. At least a portion of a rotating part 341 of the booster motor 340 may be located at the inner center of the booster fan 330.

The booster fan 330 may be a sirocco fan. The booster motor 340 may be an outer rotor type motor in which a rotor is disposed outside a stator.

The fan motor module 330 and 340 may be implemented in an integral form by inserting at least a portion of the rotating part 341 of the booster motor 340 into a central depressed portion 331 of the booster fan 330.

Because the booster fan 330 and the booster motor 340 are integrated to constitute the fan motor module 330 and 340, the size of the product may be reduced. Further, because the rotating part 341 of the booster motor 340 and the booster fan 330 are integrated, vibration caused by imbalance between the fan and the motor may be eliminated.

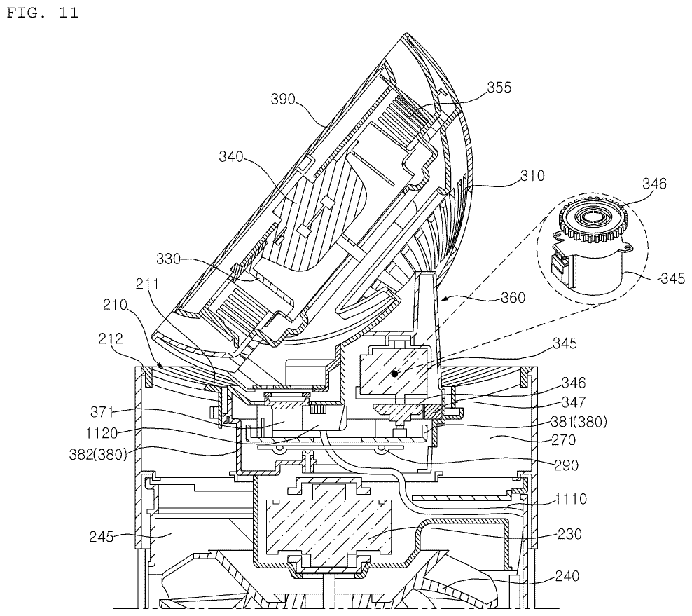

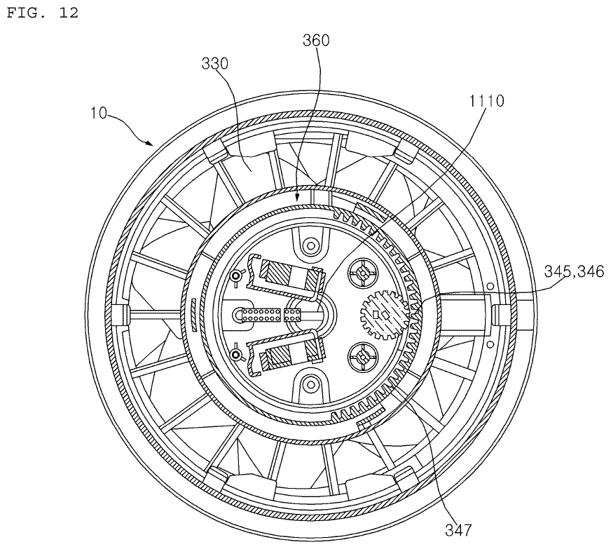

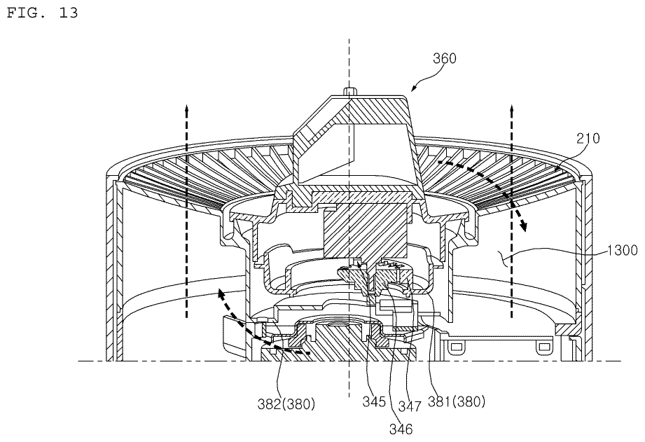

FIG. 11 is a cross-sectional view of the booster module according to the embodiment of the present disclosure, FIG. 12 is a bottom view of the booster module according to the embodiment of the present disclosure, and FIG. 13 is a view for explaining rotational operation of the booster module according to the embodiment of the present disclosure.

Referring to FIGS. 11 to 13, the booster neck 360 supports the booster module 300 from below. The head rotating part 380 is coupled to a lower side of the booster neck 360.

The head rotating part 380 includes an upper rotating-part case 381 and a lower rotating-part case 382 located below the upper rotating-part case 381. A rotary bearing 290 and various wires 1110 may be accommodated in a space defined between the upper rotating-part case 381 and the lower rotating-part case 382.

The upper rotating-part case 381 may be coupled to the booster neck 360. The lower rotating-part case 382 may be coupled to another mechanical structure of the second air cleaning module 200. For example, the lower end of the lower rotating-part case 382 may be coupled to an upper side of the second fan housing 245. Alternatively, a separate coupling part may be provided between the lower end of the lower rotating-part case 382 and the upper end of the second fan housing 245.

The upper discharge grille 210 disposed at the top of the second air cleaning module 200 has a ring shape having a central cavity formed therein. A structure for coupling to the booster module 300 is disposed in the central cavity of the upper discharge grille 210, and a plurality of grilles forming the second discharge port 210a is disposed at a peripheral portion of the upper discharge grille 210. The plurality of grilles may interconnect the inner wall 211 and the outer wall 212, and may be disposed in a radial form.

The booster neck 360 may be coupled to the rear cover 310 and/or the outer cover 320. A portion of the booster neck 360 may pass through the opening of the rear cover 310, and the remaining portion of the booster neck 360 may be located below the rear cover 310.

In order not to block the airflow discharged through the upper discharge grille 210, the booster neck 360 and the head rotating part 380 are coupled to each other inside the upper discharge grille 210. At least a portion of the head rotating part 380 may rotate together with the booster module 300.

The booster neck 360 and the head rotating part 380 are coupled to each other in the central cavity of the upper discharge grille 210. That is, the booster neck 360 and the head rotating part 380 may be coupled to each other inside the cylindrical inner wall 211 of the upper discharge grille 210.

A motor 345 configured to rotate the booster module 300 in a first direction is disposed inside the booster neck 360. Because the motor 345 is located inside the booster neck 360, which is a support structure of the booster module 300, the motor 345 does not block the inner flow path of the second air cleaning module 200 that is connected to the discharge port 210a of the upper discharge grille 210.

The motor 345 generates driving force for rotation of the booster module 300. For example, the motor 345 may be a stepper motor, the rotational angle of which is easily controlled. In addition, a motor capable of rotating bidirectionally may be included in the motor 345.

A first gear 346 is connected to the motor 345. The first gear 346 may be coupled to the motor shaft of the motor 345. The first gear 346 may be connected to and rotated by the motor 345.

The first gear 346 is tooth-engaged with a second gear 347. The second gear 347 may operate in cooperation with the first gear 346 and may extend so as to be round in the circumferential direction. The second gear 347 is a guide rail that guides rotational motion and includes a plurality of gear teeth. The first gear 346 also includes a plurality of gear teeth. The second gear may be a type of rack gear disposed in a circular arc form. When the motor 345 is driven, the first gear 346 rotates while being engaged with the second gear 347.

As the motor 345 is driven, the first gear 346 is rotated and operates in cooperation with the second gear 347. In this case, because the second gear 347 is a fixed component, the first gear 346 may be moved along the second gear 347.

The motor 345 may be located eccentrically from the rotation axis of the booster module 300. The first gear 346 may be rotated with a set rotation radius about the rotation axis. The second gear 347 may be formed with a length corresponding to the rotation amount or rotation angle of the booster module 300.

As the motor 345 is driven, the booster module 300 may be rotated in a first direction. The first direction may be the clockwise direction or the counterclockwise direction with respect to the axial direction of the second blower fan 240. When the motor 345 rotates, the first gear 346 may be rotated. The motor 345 may rotate in the clockwise direction or the counterclockwise direction with respect to the axial direction of the second blower fan 240, and the first gear 346 may be rotated in the clockwise direction or the counterclockwise direction in response thereto.

For example, when the motor 345 rotates in the clockwise direction, the first gear 346 may be moved in the counterclockwise direction. Conversely, when the motor 345 rotates in the counterclockwise direction, the first gear 346 may be moved in the clockwise direction.

As the first gear 346 is moved in the clockwise direction or the counterclockwise direction, the booster module 300 may be rotated in the same direction as the movement direction of the first gear 346.

The rotary bearing 290 may be located below the upper case 381. The rotary bearing 290 may reduce frictional force generated during rotation of the booster module 300 in the first direction.

According to the embodiment of the present disclosure, as the motor 345 rotates, the booster module 300, the booster neck 360, and the upper case 381 may be rotated.

Because the motor 345 for rotation of the booster module 300 is mounted inside the booster neck 360 rather than in the flow path, flow resistance may be reduced, and air cleaning performance may be improved.

The second air cleaning module 200 includes a wire 1110 passing through holes formed in the upper case 381 and the lower case 382 and a first terminal 1120 connected to the wire 1110 and exposed above the upper case 381.

The power module 370 of the booster module 300 includes a second terminal 371 that is in contact with the first terminal 1120 above the upper case 381.

The second terminal 371 of the power module 370 may be exposed below the booster neck 360 and may be in contact with the first terminal 1120 of the second air cleaning module 200.

According to the embodiment, the air cleaner 1 may further include a switch configured to allow or interrupt supply of power in the state in which the second terminal 371 and the first terminal 1120 are in contact with each other.

When the booster module 300 is mounted on the top of the second air cleaning module 200, the second terminal 371 of the booster module 300 comes into contact with the first terminal 1120 of the second air cleaning module 200. The booster module 300 and the second air cleaning module 200 have a contact power supply structure, and when the second terminal 371 comes into contact with the first terminal 1120, current may be transmitted to the booster module 300 from the second air cleaning module 200.

The power module 370 receives power from the second air cleaning module 200 through the second terminal 371. In addition, the power module 370 may supply power to the display panel 390, the booster motor 340, and the booster fan 330.

The booster motor 340 and the booster fan 330 may be integrated to constitute the fan motor module 330 and 340. The fan motor module 330 and 340 is disposed inside the outer cover 320 and the inner grille 355. In addition, the fan motor module 330 and 340 is disposed on the front surfaces of the rear cover 310 and the rear suction grille 311.

Each of the first and second terminals 1120 and 371 may include a power terminal configured to supply power and a signal terminal configured to transmit signals. That is, the first and second terminals 1120 and 371 may serve not only to transmit power but also to transmit signals.

The booster module 300 is provided in order to send purified air away. If the motor, which is a rotary part for control of the direction of an airflow, is located in a flow path 1300, the motor blocks a portion (e.g., about 15%) of the flow path 1300, thus causing flow resistance and deteriorating air cleaning performance. Referring to FIG. 13, in the conventional air cleaner, the motor is disposed at a position that blocks a portion of the flow path 1300 through which purified air rises. Thus, the motor and the gear structure act as obstacles to the flow of air. Due to the motor and the gear structure blocking the flow path, air flows left and right, rather than rising straight. In this way, the motor and the gear structure interfere with the rising flow of air, thereby increasing flow resistance.

According to the present disclosure, because the motor 345 for rotation of the booster module 300 is disposed inside the booster neck 360, the flow path 1300 is completely open without being blocked by the motor and the gear structure, whereby flow resistance may be minimized.

In addition, according to the present disclosure, energy required for display of information and rotation of the booster module 300 may be supplied through the contact power supply structure, and demounting and mounting of the booster module 300 may be conveniently implemented.

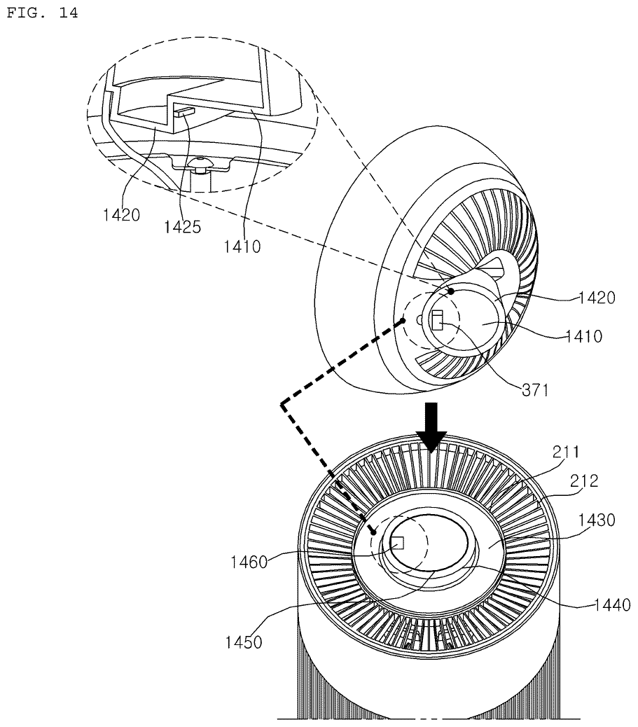

FIG. 14 is a view for explaining mounting and demounting of the booster module according to the embodiment of the present disclosure.

Referring to FIG. 14, the booster neck 360 may include a lower cover 1410 forming the bottom surface of the booster neck 360 and a ring-shaped first peripheral portion 1420 disposed outside the periphery of the lower cover 1410.

The first peripheral portion 1420 may protrude downward from the lower cover 1410. A hook 1425 for coupling to the second air cleaning module 200 is disposed on a side surface of the first peripheral portion 1420 that protrudes downward from the lower cover 1410.

A portion of the lower cover 1410 may be open so that the second terminal 371 of the power module 370 is exposed downwardly. The second terminal 371 may be exposed downwardly through the opening of the lower cover 1410.

The upper discharge grille 210 forming the discharge port 210a is disposed at the top of the second air cleaning module 200. The upper discharge grille 210 may include a cylindrical inner wall 211, a cylindrical outer wall 212, and a plurality of grilles disposed in a radial form between the inner wall 211 and the outer wall 212.

An upper case 1450 and a lower case 1440 are disposed inside the upper discharge grille 210. The lower case 1440 may be located below the upper case 1450.

One surface of the lower case 1440 may have a ring shape having a central cavity formed therein. In addition, the side surface and the rear surface of the lower case 1440 that support the ring-shaped surface thereof may define a space in which a wire connected to the first terminal 1460 is accommodated. An end portion of the ring-shaped peripheral portion of the lower case 1440 is illustrated in FIG. 14 as being exposed upwardly.

The upper case 1450 may be located above the ring-shaped peripheral portion of the lower case 1440 in accordance with the bottom surface structure of the booster neck 360 in which the first peripheral portion 1420 disposed outside the periphery of the lower cover 1410 protrudes and the hook 1425 protrudes from the inner surface of the first peripheral portion 1420. In addition, a coupling member that is coupled to the hook 1425 may be disposed on the side surface of the upper case 1450.

The booster module 300 may be secured to the second air cleaning module 200 using the hook 1425. Because the booster module 300 is easily separated upwardly, the user may conveniently clean the rear suction grille 311 and the upper discharge grille 210 after separating the booster module 300.

The upper case 1450 may be the aforementioned upper rotating-part case 381, and the lower case 1460 may be the aforementioned lower rotating-part case 382.

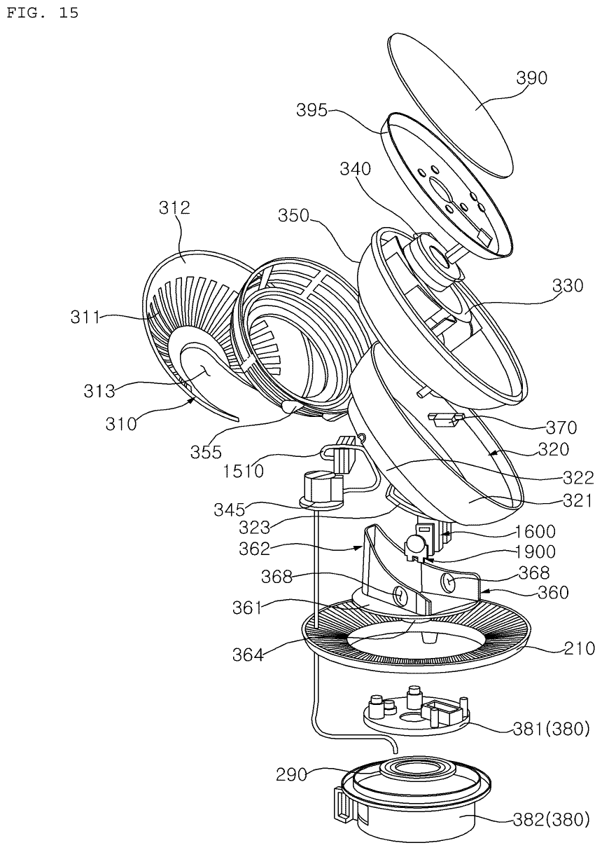

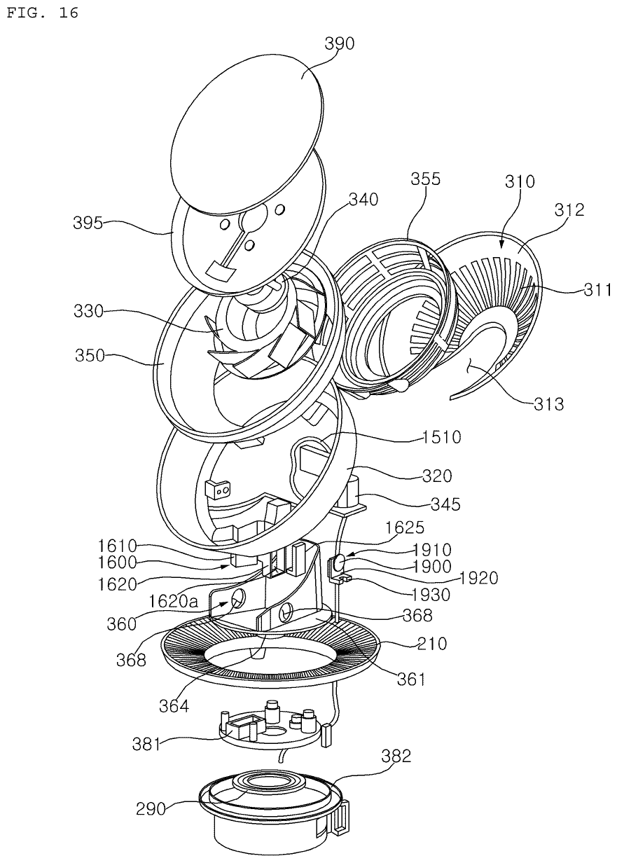

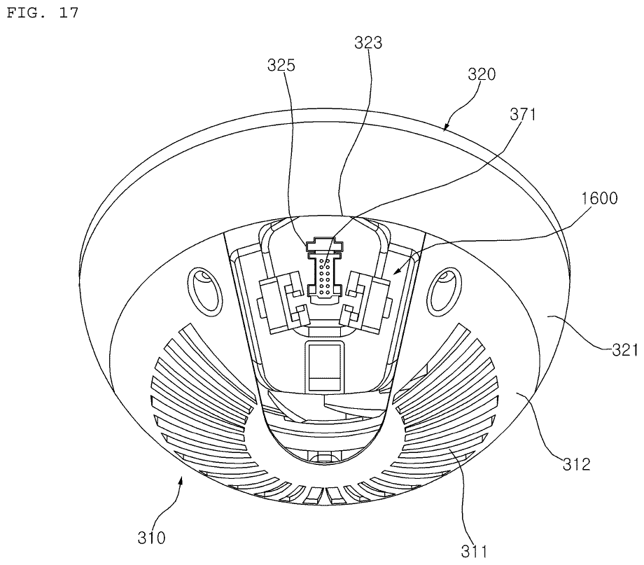

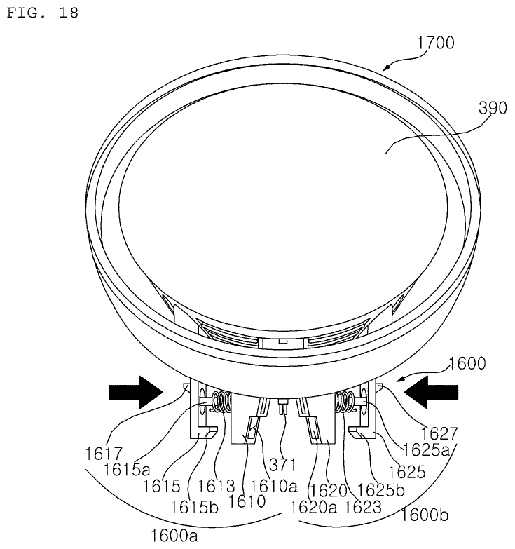

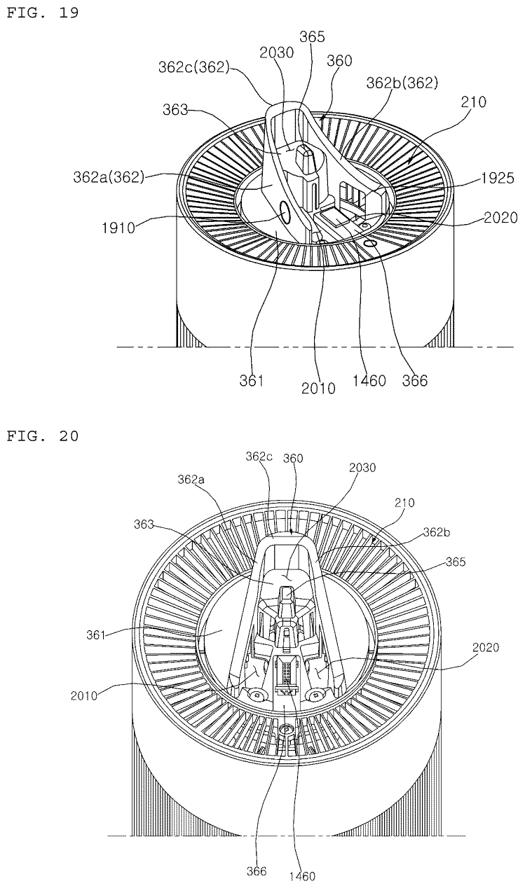

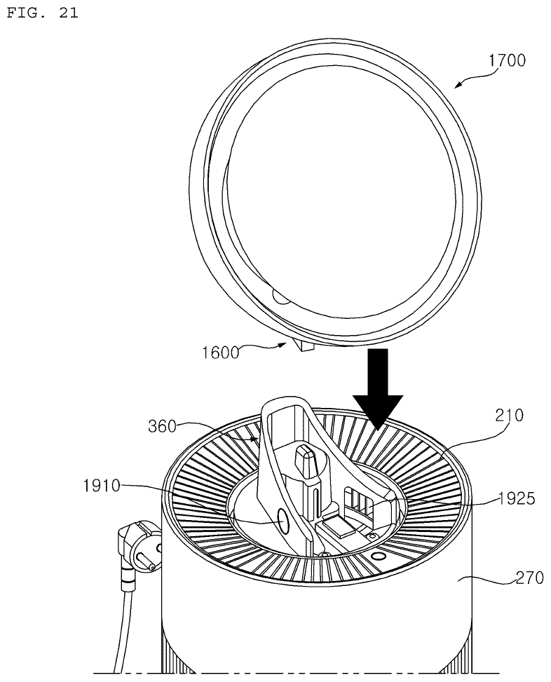

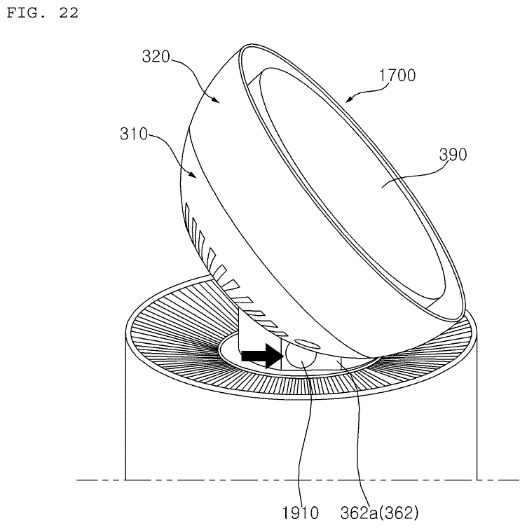

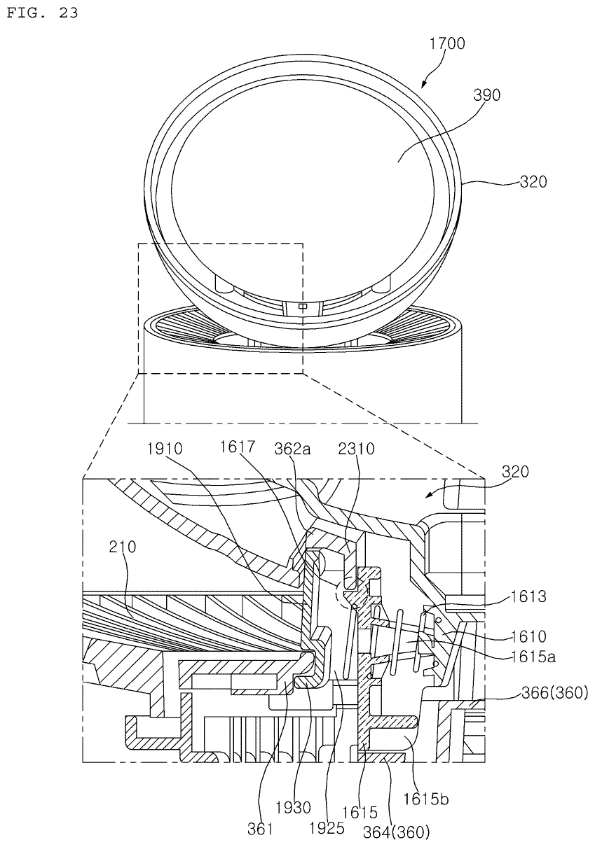

FIGS. 15 and 16 are exploded views of the booster module according to the embodiment of the present disclosure, and FIGS. 17 to 22 are views for explaining mounting and demounting of the booster module according to the embodiment of the present disclosure.

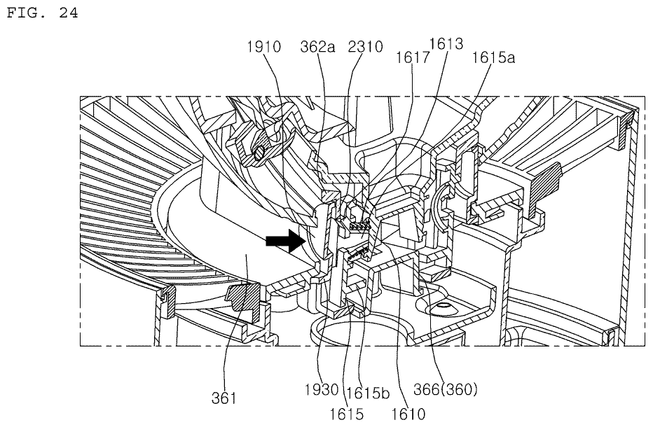

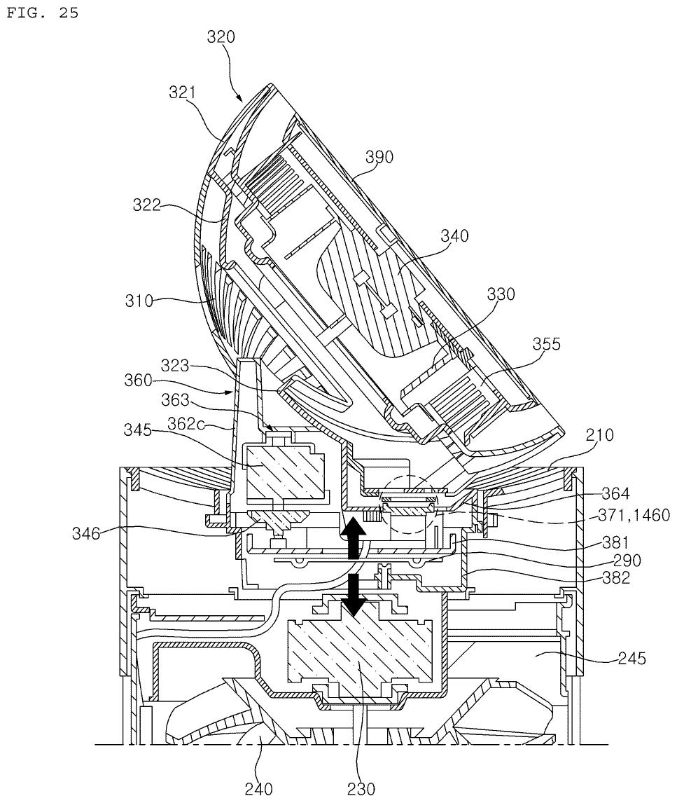

FIGS. 23 and 24 are enlarged cross-sectional views showing the coupling structure of the booster module according to the embodiment of the present disclosure, and FIG. 25 is a cross-sectional view of the booster module according to the embodiment of the present disclosure.

Referring to FIGS. 15 to 25, the display panel 390 forms the front surface of the booster module 300. The display base 395 supports the display panel 390 and accommodates a circuit board and a wire for display of information on the display panel 390.

The booster fan 330 may be disposed below the display base 395 so as not to be exposed to the user. The booster fan 330 may be a sirocco fan.

The booster motor 340 is disposed inside the booster fan 330. The booster motor 340 may be an outer rotor type motor.

The rear cover 310 and the outer cover 320 are coupled to each other to define a space for accommodating parts. The booster fan 330, the booster motor 340, the inner grille 355 in which the discharge port 355a is formed, and the inner flow guide 350 that changes the flow direction of air discharged through the discharge port 355a of the inner grille 355 may be disposed in the inner space of the outer cover 320. The rear cover 310 may include the rear suction grille 311.

The booster module 300 may be removably mounted to the upper side of the second air cleaning module 200.

The booster neck 360 may support the booster module 300 and may be coupled to the upper side of the second air cleaning module 200. The booster neck 360 may be coupled to the mechanical structure of the second air cleaning module 200 inside the upper discharge grille 210.

The head rotating part 380 may be located below the booster neck 360. The head rotating part 380 includes the upper rotating-part case 381 and the lower rotating-part case 382 located below the upper rotating-part case 381. The rotary bearing 290 may be accommodated in a space defined between the upper rotating-part case 381 and the lower rotating-part case 382. In addition, wires may be connected to the power module 370, the motor 345, and the ionizer 1510 through the head rotating part 380.

The motor 345 configured to generate power for rotation of the booster module 300 may be disposed inside the booster neck 360. The motor 345 may be disposed inside the booster neck 360 so as not to block the upper discharge airflow from the second air cleaning module 200. The motor 345 may be a stepper motor, the rotational angle of which is easily controlled.

The upper case 381 may be coupled to the booster neck 360, and the lower case 382 may be coupled to the upper side of the second fan housing 245.

The booster module 300 includes a pair of fastening parts 1600 coupled to the outer cover 320. The pair of fastening parts 1600 may be located below the booster head 1700 supported by the booster neck 360.

The pair of fastening parts 1600 includes support rods 1610 and 1620 coupled to the outer cover 320, springs 1613 and 1623 connected to the support rods 1610 and 1620, and plates 1615 and 1625 connected to the springs 1613 and 1623, respectively. In addition, the pair of fastening parts 1600 further includes hooks 1617 and 1627 coupled to the booster neck 260, respectively.

The pair of fastening parts 1600 includes a first fastening part 1600a and a second fastening part 1600b, which are coupled to the lower side of the outer cover 320.

The first fastening part 1600a includes a first plate 1615 disposed at the outermost position, a first hook 1617 protruding outward from the first plate 1615 to be coupled to the booster neck 360, a first support rod 1610 disposed at the innermost position and coupled to the lower side of the outer cover 320, and a first spring 1613 disposed between the first plate 1615 and the first support rod 1610.

In addition, a first protruding portion 1615a may be formed on one surface (inner surface) of the first plate 1615 so as to protrude toward the first support rod 1610. The first spring 1613 may be wound around the first protruding portion 1615a.

In addition, a third protruding portion 1615b may be formed on one surface (inner surface) of the first plate 1615 at a position below the first protruding portion 1615a so as to protrude toward the first support rod 1610. When the first plate 1615 is pressed, the third protruding portion 1615b is moved in the inward direction (toward the first support rod 1610). The movement of the first plate 1615 may be restricted by contact between the third protruding portion 1615b and the booster neck 360. The third protruding portion 1615b may be a stopper that restricts movement of the first plate 1615.

The second fastening part 1600b includes a second plate 1625 disposed at the outermost position, a second hook 1627 protruding outward from the second plate 1625 to be coupled to the booster neck 360, a second support rod 1620 disposed at the innermost position and coupled to the lower side of the outer cover 320, and a second spring 1623 disposed between the second plate 1625 and the second support rod 1620.

In addition, a second protruding portion 1625a may be formed on one surface (inner surface) of the second plate 1625 so as to protrude toward the second support rod 1620. The second spring 1623 may be wound around the second protruding portion 1625a.

In addition, a fourth protruding portion 1625b may be formed on one surface (inner surface) of the second plate 1625 at a position below the second protruding portion 1625a so as to protrude toward the second support rod 1620. When the second plate 1625 is pressed, the fourth protruding portion 1625b is moved in the inward direction (toward the second support rod 1620). The movement of the second plate 1625 may be restricted by contact between the fourth protruding portion 1625b and the booster neck 360. The fourth protruding portion 1625b may be a stopper that restricts movement of the second plate 1625.

In addition, the first support rod 1610 and the second support rod 1620 may include openings 1610a and 1620a that are open in the inward direction. For example, the openings 1610a and 1620a may be formed in the lower sides of the first support rod 1610 and the second support rod 1620.

The third protruding portion 1615b may pass through the opening 1610a in accordance with movement of the first plate 1615, and the fourth protruding portion 1625b may pass through the opening 1620a in accordance with movement of the second plate 1625.

The booster module 300 includes the power module 370. The second terminal 371 of the power module 370 may be exposed downwardly from the booster neck 360 and may be in contact with the first terminal 1460 of the second air cleaning module 200. The second terminal 371 may be exposed downwardly between the first support rod 1610 and the second support rod 1620. For example, the second terminal 371 may be disposed on the center line of the booster module 300. The first fastening part 1600a and the second fastening part 1600b may be disposed symmetrically to each other with respect to the center of the booster module 300. The first fastening part 1600a and the second fastening part 1600b may be symmetric to each other with respect to the second terminal 371. Although FIGS. 23 and 24 illustrate the first fastening part 1600a and the coupling structure thereof in an enlarged manner, it will be apparent that the second fastening part 1600b and the coupling structure thereof are capable of being implemented in the same manner so as to be symmetric to the first fastening part 1600a and the coupling structure thereof.

The booster neck 360 may include a neck plate 361 having a general disc shape and a neck base 362 extending upward from the neck plate 361 to support the outer cover 320 from below.

In addition, the booster neck 360 may further include a first seating portion 363 protruding upward from the inside of the neck base 362.

The first seating portion 363 may support the rear cover 310 and/or the outer cover 320 from below. A fixing portion 365 may be formed on the first seating portion 363 so as to protrude upward, thereby supporting the booster module 300 more stably.

The motor 345 may be accommodated in the inner space of the first seating portion 363. Because the motor 345 is accommodated inside the first seating portion 363, the motor 345 does not interfere with the flow of air in the booster module 300.

The booster neck 360 may further include a second seating portion 364 protruding downward from the neck plate 361. When the booster neck 360 is viewed from above, spaces 2010 and 2020 may be defined inside the second seating portion 364. The pair of fastening parts 1600 may be inserted into and fixed in the spaces 2010 and 2020 defined in the inner upper surface of the second seating portion 364. The spaces 2010 and 2020 may be partitioned by a partition wall 366 protruding upward. A portion of the partition wall 366 may be open so that the first terminal 1460 is exposed upwardly.

The first fastening part 1600a may be inserted into and fixed in the first space 2010, and the second fastening part 1600b may be inserted into and fixed in the second space 2020.

The neck base 362 may include sidewalls 362a and 362b in which holes 368 are formed and a rear wall 362c interconnecting the sidewalls 362a and 362b. The sidewalls 362a and 362b may include sections having a smaller height than the rear wall 362c. The sidewalls 362a and 362b may gradually increase in height in a direction approaching the rear wall 362c and may be connected to the rear wall 362c.

The shapes of the sidewalls 362a and 362b may correspond to the placement inclination angle of the booster module 300 and the shapes of the rear cover 310 and the outer cover 320 constituting the rear surface of the booster module 300.

Latching portions 2310 may be formed on the inner surfaces of the sidewalls 362a and 362b so as to be coupled to the hooks 1617 and 1627.

The rear cover 310 may include a coupling portion 312 coupled to the outer cover 320 and a grille portion 311 connected to the coupling portion 312 and having a suction port formed therein. The coupling portion 312 may be provided with a latching protrusion and a fastening hole so as to be coupled to the outer cover 320.

The rear cover 310 may further include an opening 313. When the rear cover 310 and the outer cover 320 are coupled to each other, a portion 323 of the outer cover 320 may pass through the opening 313. When the rear cover 310 and the outer cover 320 are coupled to each other, the portion 323 of the outer cover 320 may form the rear surface of the booster module 300 while covering the opening 313.

The outer cover 320 may include a cylindrical booster base 321, a first part 322, which protrudes backward from the booster base 321, has a fastening hole formed therein, and is fastened to the rear cover 310 by means of a fastening member such as a screw, and a second part 323, which protrudes backward from the first part 322 and covers the opening 313.

The first fastening part 1600a and the second fastening part 1600b may be coupled to the second part 323.

A terminal hole 325 through which the second terminal 371 passes may be formed in the second part 323. The terminal hole 325 may be formed between the first fastening part 1600a and the second fastening part 1600b.

When the first fastening part 1600a is inserted into the first space 2010, the sidewall 362a and the partition wall 366, which are located on the left and right sides of the first space 2010, may press the first fastening part 1600a, and the placement state of the first support rod 1610 may be maintained by the elasticity of the first spring 1613 between the first support rod 1610 and the first plate 1615.

When the second fastening part 1600b is inserted into the second space 2020, the sidewall 362b and the partition wall 366, which are located on the left and right sides of the second space 2020, may press the second fastening part 1600b, and the placement state of the second support rod 1620 may be maintained by the elasticity of the second spring 1623 between the second support rod 1620 and the second plate 1625.

The booster module 300 may include a pair of button modules 1900 that presses the first fastening part 1600a and the second fastening part 1600b when mounted.

Each of the button modules 1900 may include a button 1910 inserted into the hole 368 and a body 1920 supporting the button 1910. For example, the hole 368 may be formed in a circular shape, and the circular button 1910 may be inserted into the hole 368 and exposed to the outside. The hole 368 and the button 1910 may have other shapes, such as a rectangular shape.

Each of the button modules 1900 may further include a protruding portion 1930 protruding from the lower end of the body 1920. The protruding portion 1930 may be in contact with the neck plate 361. The protruding portion 1930 may be located below the neck plate 361.

When the user applies force to the button 1910, the plates 1615 and 1625 may be pressed inwardly, and the booster head 1700 connected to the upper sides of the first fastening part 1600a and the second fastening part 1600b may be separated upwardly from the fixing space.

Each of the button modules 1900 may further include a protrusion 1925 protruding from the rear surface of the body 1920. When the button 1910 is pressed, the protrusion 1925 may apply force to the plates 1615 and 1625. Accordingly, the user may separate the booster module 300 by pressing the button 1910 with smaller force.

The protrusion 1925 may be provided in plural, and the plurality of protrusions 1925 may be disposed so as to be spaced apart from each other. Accordingly, the force applied to the plates 1615 and 1625 may be distributed evenly.

As is apparent from the above description, according to at least one of the embodiments of the present disclosure, a booster module includes an outer cover and a pair of fastening members coupled to the outer cover, and each of the pair of fastening members includes a hook coupled to the outer cover, a spring connected to the hook, and a plate connected to the spring. Accordingly, demounting and mounting of the booster module may be further facilitated.

According to at least one of the embodiments of the present disclosure, the booster module includes a booster fan, a booster motor configured to rotate the booster fan, an outer cover, and first and second fastening parts coupled to the outer cover, the first fastening part includes a first plate, a first hook protruding outward from the first plate to be coupled to the booster neck, a first support rod coupled to a lower side of the outer cover, and a first spring disposed between the first plate and the first support rod, and the second fastening part includes a second plate, a second hook protruding outward from the second plate to be coupled to the booster neck, a second support rod coupled to a lower side of the outer cover, and a second spring disposed between the second plate and the second support rod. Accordingly, demounting and mounting of the booster module may be further facilitated.

According to at least one of the embodiments of the present disclosure, because a terminal of a power module is disposed below the booster neck supporting the booster module, it is possible to implement a power supply structure suitable for demounting and mounting of the booster module.

According to at least one of the embodiments of the present disclosure, the booster neck includes a lower cover forming a bottom surface of the booster neck, a ring-shaped first peripheral portion disposed outside the periphery of the lower cover and protruding downward from the lower cover, and a hook disposed on a protruding side surface of the first peripheral portion. Accordingly, demounting and mounting of the booster module may be further facilitated.

According to at least one of the embodiments of the present disclosure, because a first air cleaning module configured to discharge purified air through the bottom thereof is disposed at a lower position and a second air cleaning module configured to discharge purified air through the top thereof is disposed at an upper position, it is possible to prevent air discharged from the first air cleaning module from being introduced into the second air cleaning module and to improve air cleaning performance.

According to at least one of the embodiments of the present disclosure, because the booster module is configured such that a display panel is disposed so as to cover the entirety of the front surface of the booster fan and air is discharged through a slit formed beside the display panel, it is possible to prevent dust from accumulating on the booster fan and an inner grille.

According to at least one of the embodiments of the present disclosure, because the booster fan and the booster motor for rotating the booster fan are formed integrally, it is possible to reduce vibration and noise.

The effects achievable through the disclosure are not limited to the above-mentioned effects, and other effects not mentioned herein will be clearly understood by those skilled in the art from the description of the claims.

Although the present disclosure has been described with reference to specific embodiments shown in the drawings, it is apparent to those skilled in the art that the present disclosure is not limited to these embodiments and is embodied in many forms without departing from the scope of the present disclosure, which is described in the following claims. These modifications should not be individually understood from the technical spirit or scope of the present disclosure.

What is claimed is:

1. An air cleaner comprising:
a case including a first suction port disposed at a peripheral surface of the case;
an air cleaning module;
a booster module removably mounted to an upper side of the air cleaning module, the booster module comprising a booster fan, an outer cover, and a first fastening part and a second fastening part each coupled to the outer cover, the first fastening part comprising:
a first plate;
a first hook protruding outward from the first plate;
a first support rod coupled to a lower side of the outer cover; and
a first spring disposed between the first plate and the first support rod, and
the second fastening part comprising:
a second plate;
a second hook protruding outward from the second plate;
a second support rod coupled to the lower side of the outer cover; and
a second spring disposed between the second plate and the second support rod; and
a booster neck configured to support the booster module, the booster neck being configured to couple to the first hook and the second hook.

2. The air cleaner according to claim 1, wherein the first fastening part further comprises a first protruding portion disposed on one surface of the first plate, the first protruding portion protruding toward the first support rod and being configured to allow the first spring to be wound around the first protruding portion, and
wherein the second fastening part further comprises a second protruding portion disposed on one surface of the second plate, the second protruding portion protruding toward the second support rod and being configured to allow the second spring to be wound around the second protruding portion.

3. The air cleaner according to claim 2, wherein the first fastening part further comprises a third protruding portion disposed on the one surface of the first plate at a position below the first protruding portion, the third protruding portion protruding toward the first support rod, and
wherein the second fastening part further comprises a fourth protruding portion disposed on the one surface of the second plate at a position below the second protruding portion, the fourth protruding portion protruding toward the second support rod.

4. The air cleaner according to claim 1, wherein the booster module further comprises a power module comprising a second terminal configured to be in contact with a first terminal of the air cleaning module, and
wherein the second terminal is exposed downwardly between the first support rod and the second support rod.

5. The air cleaner according to claim 1, wherein the booster neck comprises:
a neck plate;
a neck base extending upward from the neck plate, the neck base being configured to support the outer cover;
a first seating portion protruding upward from an inside of the neck base; and
a second seating portion protruding downward from the neck plate.

6. The air cleaner according to claim 5, wherein the second seating portion comprises:
a first space configured to receive the first support rod; and
a second space configured to receive the second support rod.

7. The air cleaner according to claim 5, wherein the neck base comprises:
a pair of sidewalls, each of the sidewalls including a hole; and
a rear wall interconnecting the sidewalls, the rear wall having a height that is greater than a height of sections of the sidewalls.

8. The air cleaner according to claim 7, further comprising a button module, the button module comprising:
a button configured to be inserted into the hole;
a body supporting the button; and
a protrusion protruding from a rear surface of the body.

9. The air cleaner according to claim 1, further comprising a rear cover, the rear cover comprising:
a coupling portion configured to couple to the outer cover;
a second suction port including a grille portion connected to the coupling portion; and
an opening configured to receive a portion of the outer cover.

10. The air cleaner according to claim 9, wherein the outer cover comprises:
a booster base;
a first part protruding from the booster base, the first part having a fastening hole and being configured to be fastened to the rear cover by a fastening member; and
a second part protruding from the first part, the second part being configured to cover the opening, and
wherein the first fastening part and the second fastening part are coupled to the second part.

11. The air cleaner according to claim 1, wherein the air cleaning module comprises:
a first air cleaning module comprising a first blower fan disposed in the case, a first filter configured to remove foreign matter from air introduced through the first suction port, and a first discharge port disposed at a bottom of the first air cleaning module, the first discharge port being configured to discharge air filtered by the first filter; and
a second air cleaning module disposed above the first air cleaning module, the second air cleaning module comprising a second blower fan disposed in the case, a second filter configured to remove foreign matter from air introduced through the first suction port, and a second discharge port disposed at a top of the second air cleaning module, the second discharge port being configured to discharge air filtered by the second filter.

12. The air cleaner according to claim 1, wherein the booster module further comprises a booster motor including a rotating part configured to be inserted into a central depressed portion of the booster fan.

13. An air cleaner comprising:
a case including a first suction port disposed at a peripheral surface of the case;
an air cleaning module comprising a first terminal;
a booster module removably mounted to an upper side of the air cleaning module, the booster module comprising a power module configured to receive power from the first terminal of the air cleaning module, a booster fan, and a booster motor configured to rotate the booster fan, the power module comprising a second terminal exposed downwardly from the booster module, the second terminal being configured to be in contact with the first terminal; and
a booster neck configured to support the booster module, the booster neck comprising:
a lower cover that is a bottom surface of the booster neck;
a ring-shaped peripheral portion disposed outside a periphery of the lower cover and protruding downward from the lower cover; and
a hook disposed on a protruding side surface of the peripheral portion.

14. The air cleaner according to claim 13, wherein the lower cover comprises an open portion configured to allow the second terminal to be exposed downwardly through the open portion.

15. The air cleaner according to claim 14, wherein the air cleaning module further comprises:
a blower fan disposed in the case;
a filter configured to remove foreign matter from air introduced through the first suction port;
a discharge port including an upper discharge grille located at a top of the air cleaning module;
an upper case located inside the upper discharge grille; and
a lower case located below the upper case, the lower case having a space configured to accommodate a wire connected to the first terminal.

16. The air cleaner according to claim 15, wherein the lower case comprises a ring-shaped surface having a central cavity.

17. The air cleaner according to claim 13, wherein the booster module further comprises:
a discharge port including an inner grille; and
a second suction port including a rear suction grille, and
wherein the booster fan is disposed at a front of the rear suction grille and is disposed inside the inner grille.

18. The air cleaner according to claim 17, wherein the booster module further comprises:
a display panel disposed at a front of the booster fan; and
an inner flow guide disposed between an outer cover of the booster module and the inner grille, the inner flow guide being configured to change a flow direction of air discharged through the inner grille, and
wherein the air discharged through the inner grille is configured to pass through a slit formed between the inner flow guide and the display panel.

19. The air cleaner according to claim 13, wherein the booster fan includes a sirocco fan,
wherein the booster motor includes an outer rotor type motor, and
wherein a rotating part of the booster motor is configured to be inserted into a central depressed portion of the booster fan.

20. The air cleaner according to claim 19, wherein the air cleaning module comprises:
a first air cleaning module comprising a first blower fan disposed in the case, a first filter configured to remove foreign matter from air introduced through the first suction port, and a first discharge port located at a bottom of the first air cleaning module, the first discharge port being configured to discharge air filtered by the first filter; and
a second air cleaning module disposed above the first air cleaning module, the second air cleaning module comprising a second blower fan disposed in the case, a second filter configured to remove foreign matter from air introduced through the first suction port, and a second discharge port located at a top of the second air cleaning module, the second discharge port being configured to discharge air filtered by the second filter.
